(19) United States
(12) Patent Application Publication
(10) Pub. No.: US 2008/0015913 A1
(43) Pub. Date: Jan. 17, 2008

(54) GLOBAL COMPLIANCE MANAGEMENT SYSTEM

(75) Inventors: Pat COURTNEY, New York, NY (US); Dino Deangelis, New York, NY (US)

Correspondence Address: PILLSBURY WINTHROP SHAW PITTMAN, LLP, P.O. BOX 10500, MCLEAN, VA, 22102, US

(73) Assignee: The Bank of New York, New York, NY (US)

(21) Appl. No.: 11/771,643

(22) Filed: Jun. 29, 2007

Related U.S. Application Data
(60) Provisional application No. 60/818,325, filed on Jul. 5, 2006.

(51) Int. Cl. G06Q 10/00; G06F 17/30

(52) U.S. Cl. 705/7

(57) ABSTRACT

A Global Compliance Management System enables automated compliance tracking, monitoring, and reporting of regulatory exams, business unit information, and risk management information related to regulatory management and reporting.

### CROSS-REFERENCE TO RELATED APPLICATIONS

The application claims the benefit of U.S. provisional application Ser. No. 60/818,325, filed Jul. 5, 2006. The entire contents of the '325 application are incorporated herein by reference.

### FIELD OF THE INVENTION

The invention relates to regulatory monitoring, assessment, and compliance. More specifically, the invention regards systems, methods, and apparatus that can be used to track or manage compliance with local and foreign laws and rules, across one or more jurisdictions, that affect or potentially affect a business or other entity.

### BACKGROUND

Numerous rules and regulations govern how an entity may be structured and operated. These can include banking laws and rules that dictate reporting requirements to applicable regulatory bodies and environmental laws and rules that dictate how industrial processes can be carried out or should be tracked and reported. When an organization or entity operates across jurisdictional boundaries its processes and strategies may need to change in order to adapt to the laws and regulations governing its structure and operation in each specific jurisdiction. Identifying how local rules and laws affect an organization can present many challenges. Likewise, identifying and complying with tracking and reporting requirements across many different jurisdictions can also be a challenging endeavor. Still further, when an organization operates across jurisdictions, identifying compliance risks or vulnerabilities in each of these jurisdictions and providing assessment of the risks back to the organization can assist an organization to better organize and operate in specific jurisdictions and across jurisdictional boundaries. Embodiments of the present invention may be used by an organization or an individual to identify compliance issues, track these issues, report, and manage operations in compliance with the rules and laws of the applicable regulating jurisdictions.

### SUMMARY OF THE INVENTION

Systems, methods, and apparatus for managing compliance with applicable local laws and rules are embodied in the present invention. These embodiments may include establishing a comprehensive management system that can store applicable laws and rules that can affect an entity's structure or operations. This system may further include methods of tracking the requirements established by these laws and regulations and methods of promoting compliance with the laws and regulations.

Embodiments of the present invention may also be used when managing an organization across multiple jurisdictions. This can include assigning risks or potential risks for various activities and operations and assigning risks or potential risks for carrying out these activities in different jurisdictions and at different times. The invention can include methods themselves as well as systems and apparatus used to carry out portions or all steps of these methods.

In some embodiments a central repository of information may be used to store all laws and regulations that may apply to an organization in the various jurisdictions that the organization operates in. This repository may be stored as a database and may be accessible over a wide area network. This repository may be queried on an as-needed basis to assess the compliance with various operations or entities of the organization. The repository may also be involved in sending reports to notify one or more individuals about time sensitive compliance issues in various jurisdictions. These reports may be sent to a certain level of individuals in the organization as well as to different levels depending upon various factors including the timing of the report and risk associated with the law or rule. Reports may also be sent for other reasons as well. For example, they may be ad-hoc in nature and may contain an assigned risk for carrying out an activity at different dates in the future.

Embodiments may also include various modules within the repository that center around specific business issues or business operations. Moreover, the repository may have access to other databases to update its own data. This can include obtaining current data on business information, personnel in the organization and updated text of the laws and rules.

Of course there are many other embodiments of the present invention in addition to those listed both above and below. Still further, while various systems and methods are described herein, these systems and methods may be varied and changed with more or less components or steps while still being within the spirit and scope of the present invention.

### BRIEF DESCRIPTION OF THE DRAWINGS

Features, aspects, and details of the various embodiments of the invention are described in conjunction with the attached drawings.

FIG. 1 is a method that may be used in accord with the invention.

FIG. 2 is a system that may be used in accord with the invention.

FIG. 3 is an environment wherein the invention may be used.

FIG. 4 is an example of compliance officer module characteristics that may be used in accord with the invention.

FIG. 5 is an example of a screen shot of an overview of a compliance officer module that may be used in accord with the invention.

FIG. 6 is an example of a screen shot of a compliance officer module that may be used in accord with the invention.

FIG. 7 is an example a business unit structure module that may be used in accord with the invention.

FIG. 8 is an example of a law inventory module structure that may be used in accord with the invention.

FIG. 9 is an example of a screen shot of a law inventory module that may be used in accord with the invention.

FIG. 10 is an example of a monitoring scorecard module that may be used in accord with the invention.

FIG. 11 is an example of a compliance review form module that may be used in accord with the invention.

FIG. 12 is an example of a business unit self-assessment module that may be used in accord with the invention.

FIG. 13 is an example of a business unit issues and special projects module that may be used in accord with the invention.

FIG. 14 is an example of a business unit training schedule module that may be used in accord with the invention.

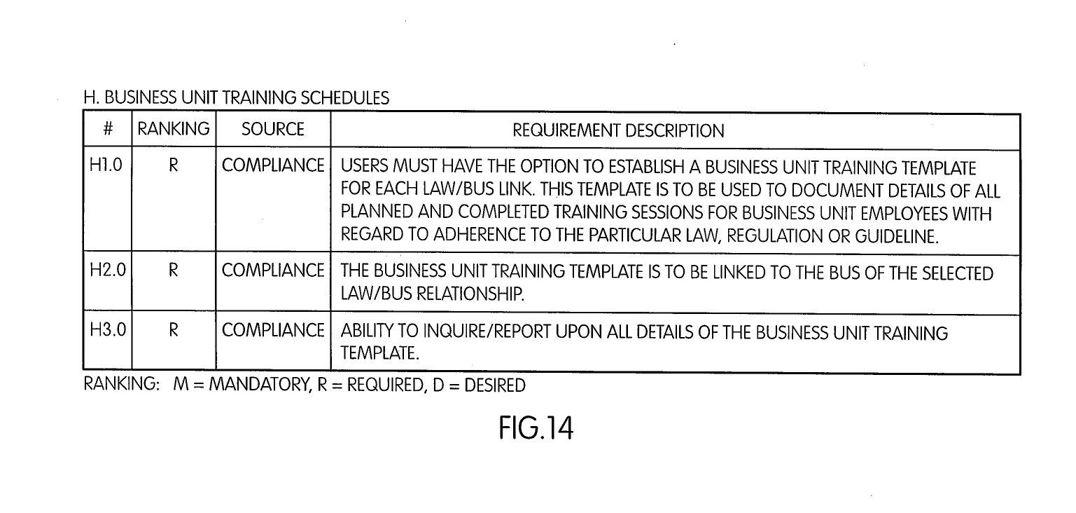

FIG. 15 is an example of a business unit initiatives module that may be used in accord with the invention.

FIG. 16 is an example of a global initiatives module that may be used in accord with the invention.

FIG. 17 is an example of a regulatory examinations module that may be used in accord with the invention.

FIG. 18 is an example of an inquiries and reporting module that may be used in accord with the invention.

FIG. 19 is an example of a general characteristics module that may be used in accord with the invention.

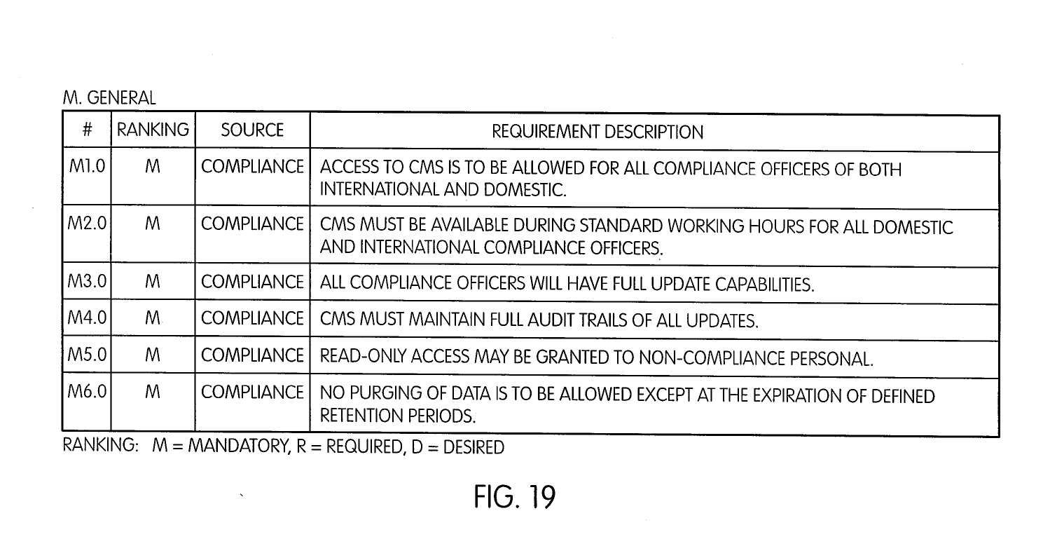

### DETAILED DESCRIPTION

In accord with one or more embodiments of the invention, a Global Compliance Management System (GCMS) may be used by an organization to promote compliance with various laws and regulations across one or more jurisdictions that the organization or entity may operate in. The GCMS may act as a central repository that stores lists of known statutes and laws. This repository may be used by compliance managers or other individuals interested in confirming compliance with the applicable laws and rules. This compliance may relate to the structure or daily operation of an entity in the jurisdiction as well as to special projects being conducted within the jurisdiction or governed by the jurisdiction.

The GCMS may be automated so as to identify applicable statutes and rules and to identify steps that need to be taken to comply with these rules and laws. These steps can include reporting criteria and steps needed for carrying out the regulated processes. The GCMS can be used to replace or supplement manual processes employed by compliance personnel in financial or other organizations. Additionally, the GCMS may serve as a comprehensive automated compliance system. In so doing it may provide a system that consolidates numerous automated solutions, manual processes, and supporting data.

In accordance with embodiments of the invention, the GCMS may be configured to assist compliance officers who monitor business units for compliance with applicable laws as well as to address concerns expressed by regulators with regards to risk assessment, issue identification, tracking and management reporting. The GCMS may also be implemented as a compliance tracking system that ensures members of a global compliance division and/or senior management of a company are made aware of outstanding/high risk issues and are provided with notice or identification of required actions in a timely manner. In some embodiments the GCMS may include an escalation process for compliance related issues. This process may alert individuals of increasing responsibility depending upon various criteria including the risk of compliance and how close an upcoming deadline is.

The GCMS may operate as an informational system that provides organization-wide access via one or more desktop applications, e.g., Lotus Notes Desktop. It may be accessible by other means as well. Likewise, it may report through mainframe printers, desktop applications, and wireless applications.

Although the primary user audience for GCMS may be the personnel assigned to regulatory and reporting compliance, the GCMS may also be a valuable tool for business units to access and track results of monitoring programs, regulatory exams, and resultant issues requiring actions. Additionally, senior management may utilize the GCMS to obtain enhanced risk management information reporting. Further, regulators may benefit either directly or long term from increased response time to inquiries. Indeed, in certain situations, regulators may be given access to the GCMS for real-time and other uses including reporting.

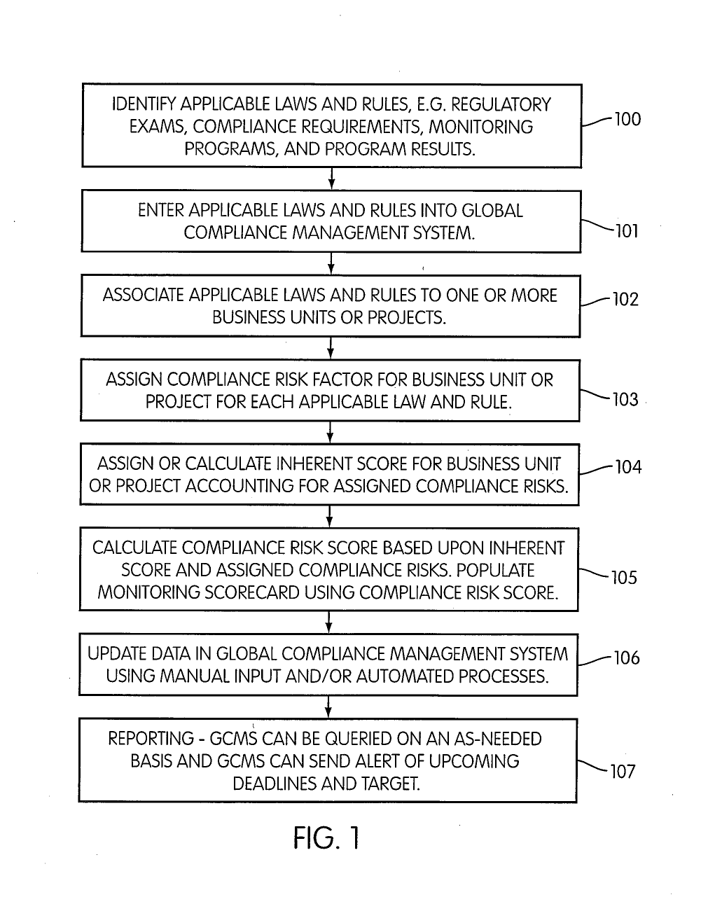

FIG. 1 is a flowchart of a method embodying the invention. While these steps are shown in a certain order, they may be performed in various orders without straying from the spirit and scope of the present invention. In step 100, the applicable rules and laws for a certain jurisdiction that may apply to an organization are identified. This may include identifying regulations governing reporting, compliance, monitoring and program results. Of course, depending on the business or purpose of an organization the applicable and relevant rules and laws identified for use with the GCMS may differ.

At step 101, identified laws and regulations may be entered into a GCMS. This may be done in various ways including through digital imagery, scanning, and downloading from regulatory servers. At step 102 the laws and regulations used in the GCMS may be associated with one or more business projects and one or more business units. In other words, in a financial organization laws governing bond trading may be assigned to the bond trading business unit and consumer lending laws may be associated with an underwriting portion of the business unit. The associations to various units and projects may be done automatically by the GCMS using predetermined criteria as well as by a compliance manager or other individual responsible for the administration of the GCMS.

At 103 a compliance risk factor may be assigned by the compliance manager or the GCMS to quantify the risk associated with each applicable rule or law. This risk factor may include the sweeping nature of the law or rule and the ease or difficulty in complying with it. For instance a rule that affects 80% of a business unit's work may have a high risk factor while one that affects 10% of the work of a business unit may have a low risk factor. These various risk factors may be cumulatively considered to formulate an inherent score for a business unit or a project. This score may be calculated at step 104 and may be used to calculate the compliance risk score of step 105. This compliance score may reflect the overall risk of compliance for a business unit or project and may be used when determining the required rate of return for the business unit.

At step 106 the GCMS may be updated to reflect the assigned scores. This update may be done manually and may be automated within the GCMS through the input of the preceding risk considerations. Having input all of this data, the GCMS may generate periodic and ad-hoc reports to ensure that compliance occurs in each jurisdiction. It may also be used when managing the business units and when evaluating alternative strategies of action. There may be other uses as well.

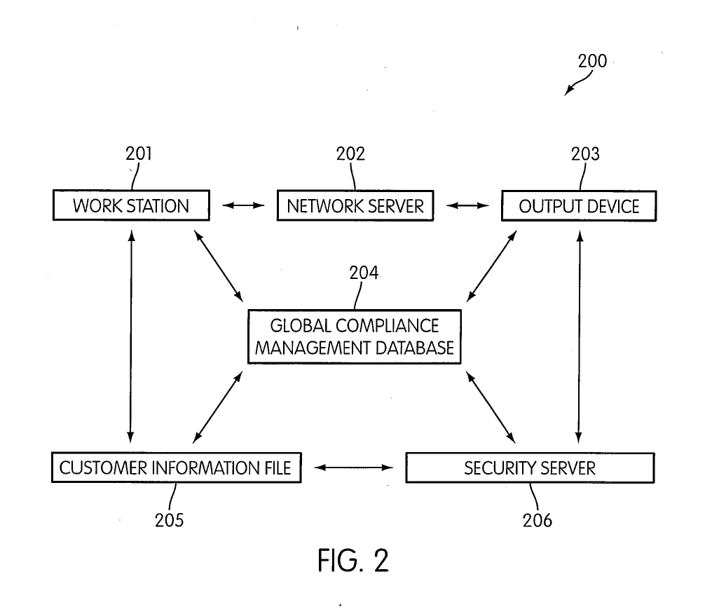

FIG. 2 shows a network that may be employed when practicing the present invention. This network 200 may include one or more work stations 201 and 203, one or more servers 202, a security server 206, and a customer information file 205. It may also include a Global Compliance Management Database 204 (GCMD). Each of these components of the network may communicate directly with each other over the network as well as through other components. The work station 201 may be used by a compliance manager to input data and receive notifications. Likewise, the work station 203 may also be used for input and reporting. The GCMD may have various security settings where certain data is protected by requiring security clearances while other data may be changed by every user. For instance, compliance risk factors may only be assigned or changed by compliance managers while a user's contact information may be changed by each of the users. Likewise, these security measures may provide access to certain data to a selected group of individuals based on their responsibilities or other requirements.

The GCMD may be queried on several factors including: specific issues, response dates, to identify trends across jurisdictions, for risk ratings, for specific entity compliance issues, for volume of tasks and for numerous other relevant topics. The GCMD may store information regarding the business units that includes sector information, organizational codes, product line information, offered services, and the names of relevant individuals, including compliance officers. The customer information file 205 may store information that can be used to associate each law and rule with a specific business unit or product line. The customer information file may also have current information regarding the most recent products offered by business units, the structure of these business units and the organizational codes used to manage the business unit. The storage carried out by the GCMD and the customer information file is preferable retained on non-volatile memory such as hard disk or tape or CD-ROM. Other storage media may be used as well.

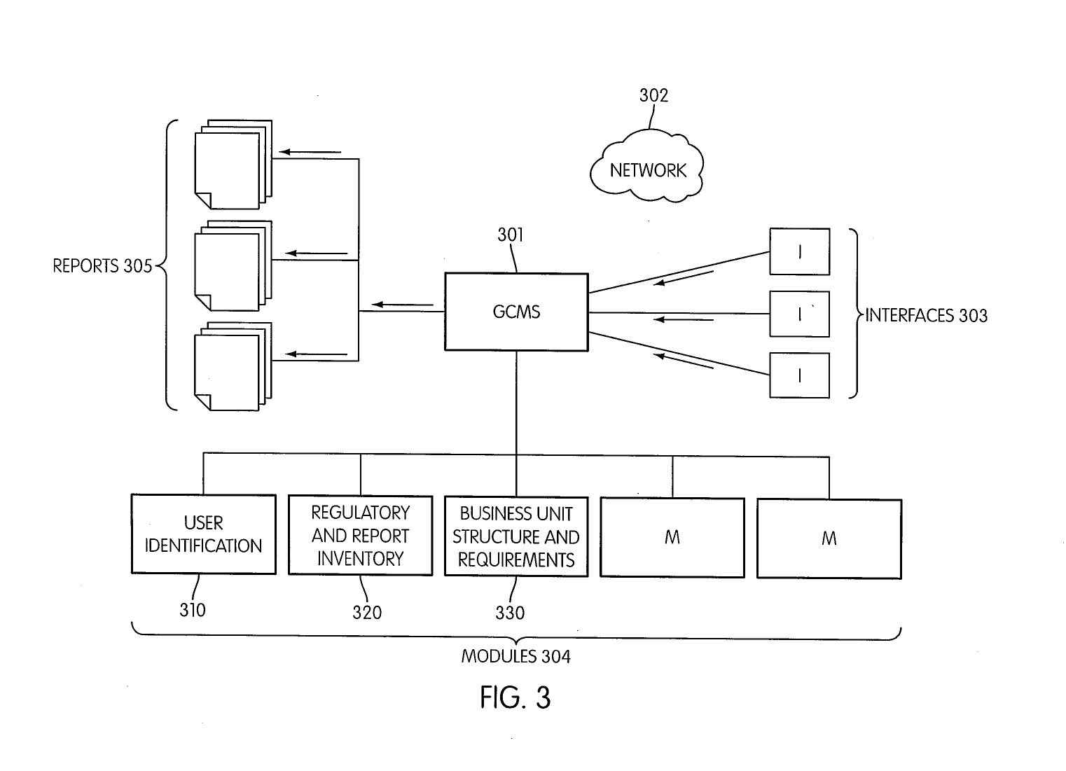

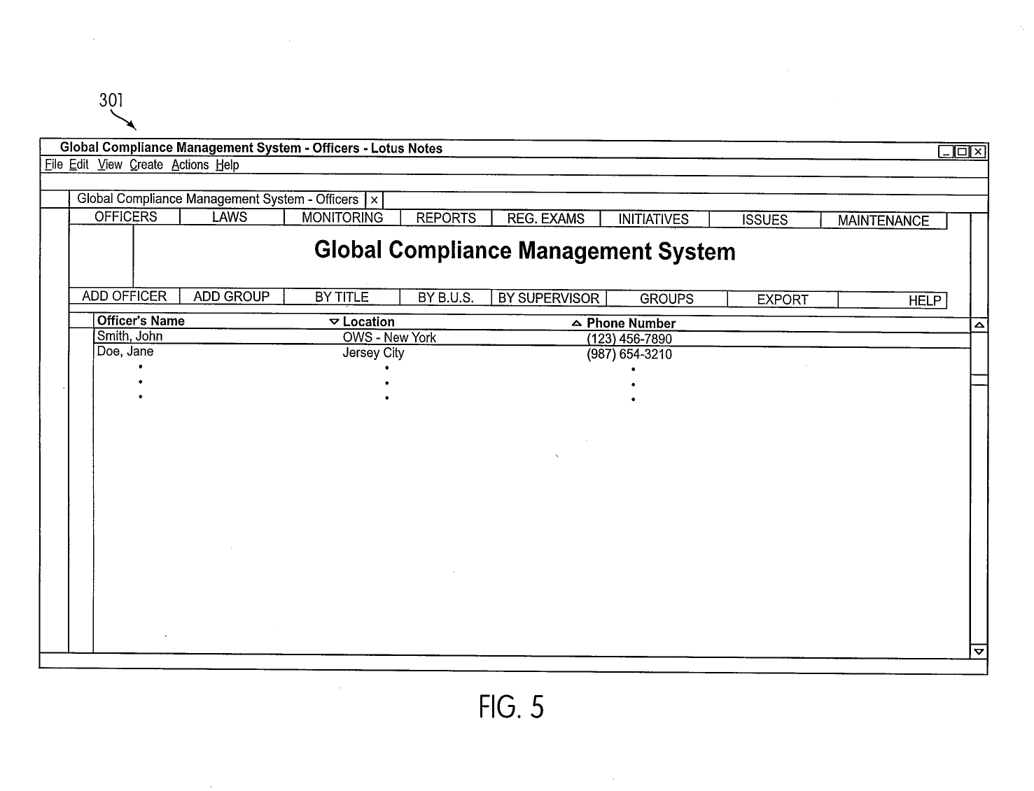

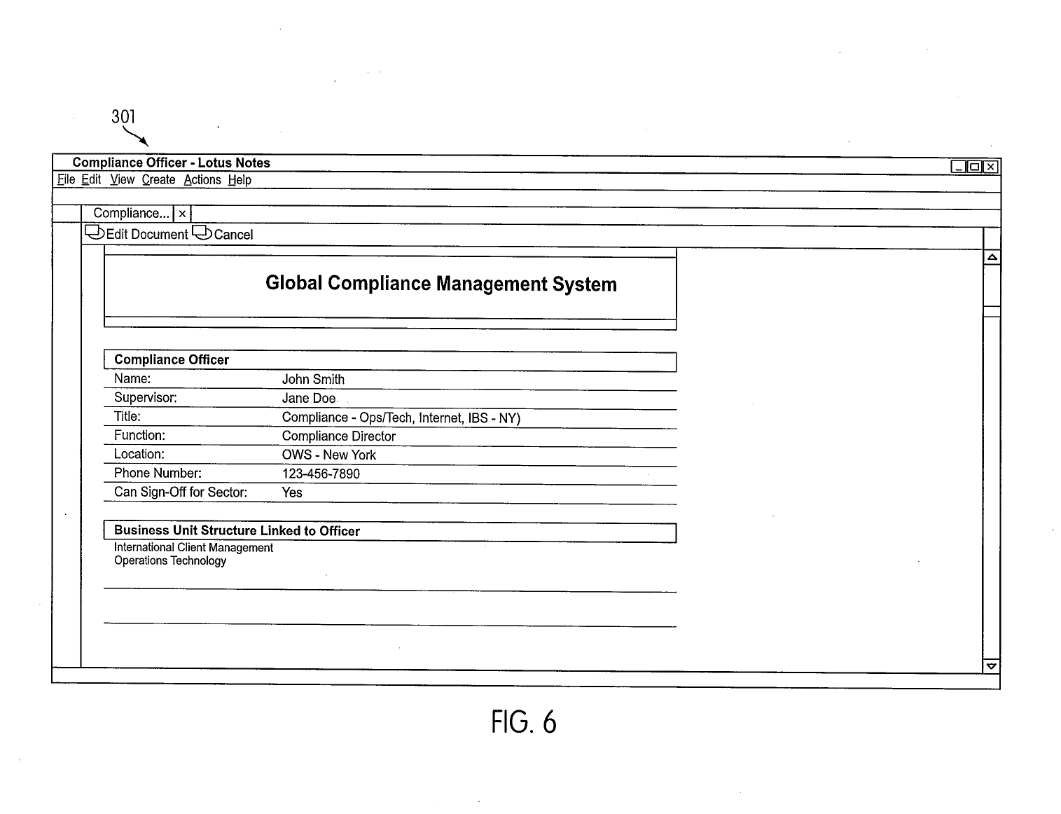

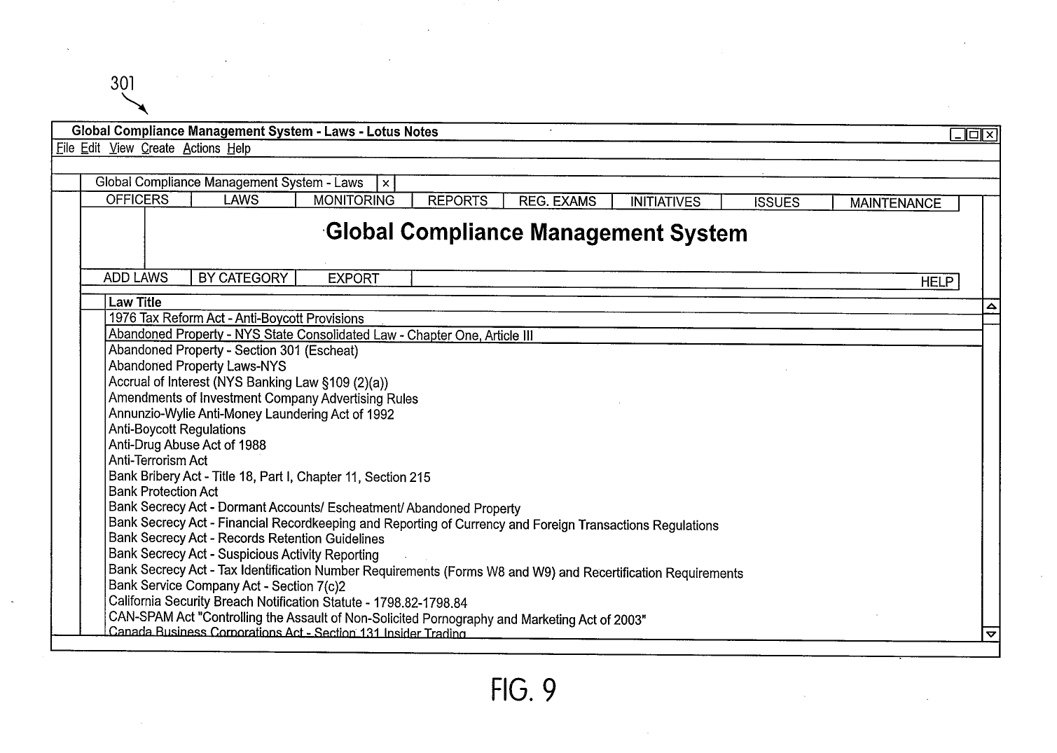

FIG. 3 shows additional detail of a GCMS embodying the present invention. In FIG. 3 a GCMS 301 is shown providing various functionality including user identification 310, regulatory and reporting inventory 320, and business unit specific requirements 330. The user identification 310, as shown in FIG. 5 and FIG. 6, may provide identification of some portion or all regulatory and reporting personnel in the company and their roles including the business units they are responsible for monitoring. The regulatory and reporting inventory 320 may provide a complete inventory of some portion or all laws and their unique characteristics, examples of which being illustrated in FIG. 9. The business unit specific requirements 330 may include identification of some portion or all business units and the laws that are applicable to their organization.

The GCMS functionality illustrated in FIG. 3 may be bound in a relationship that all or some portion of all required actions and/or documentation may be linked to monitoring scorecards, monitoring programs, regulatory exams, business unit self-assessments, issues/action steps and global and business unit specific initiatives. Via the relationship of elements and the linkage of associated data, inquiries upon any element in the link can easily provide information regarding all other elements in the link, all or some portion of monitoring programs conducted for that business unit, all or some portion of business units where a law is applicable and the risk assessment, or all or some portion of issues identified for a business unit and the status of the action steps required for issue resolution.

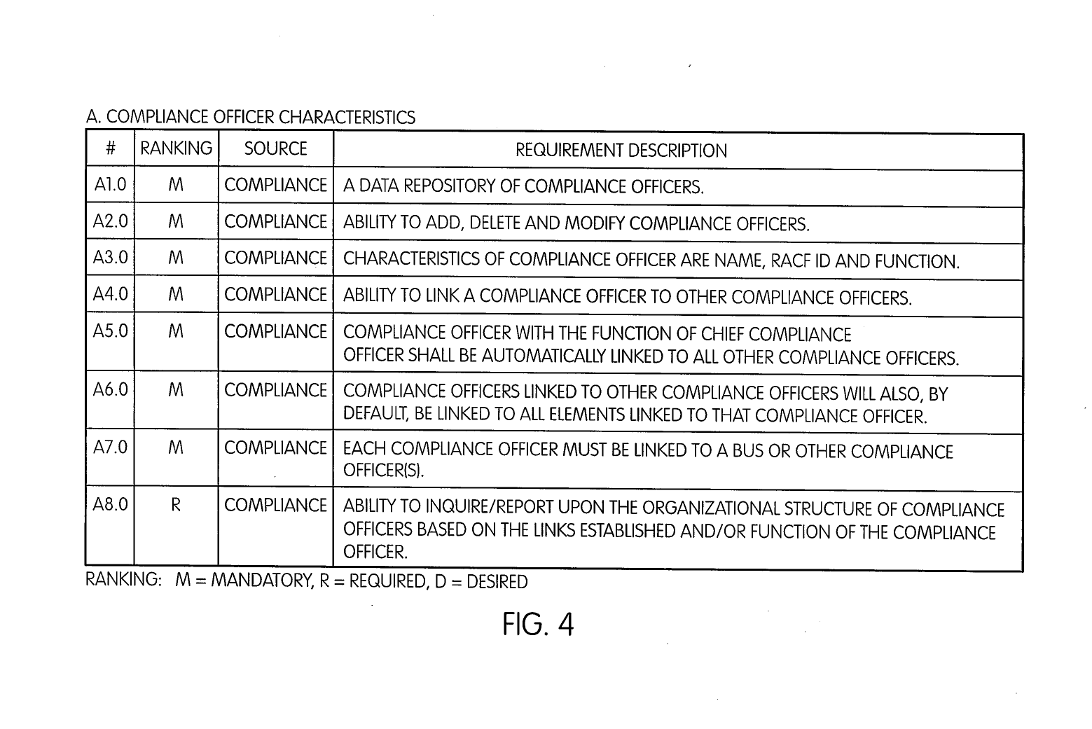

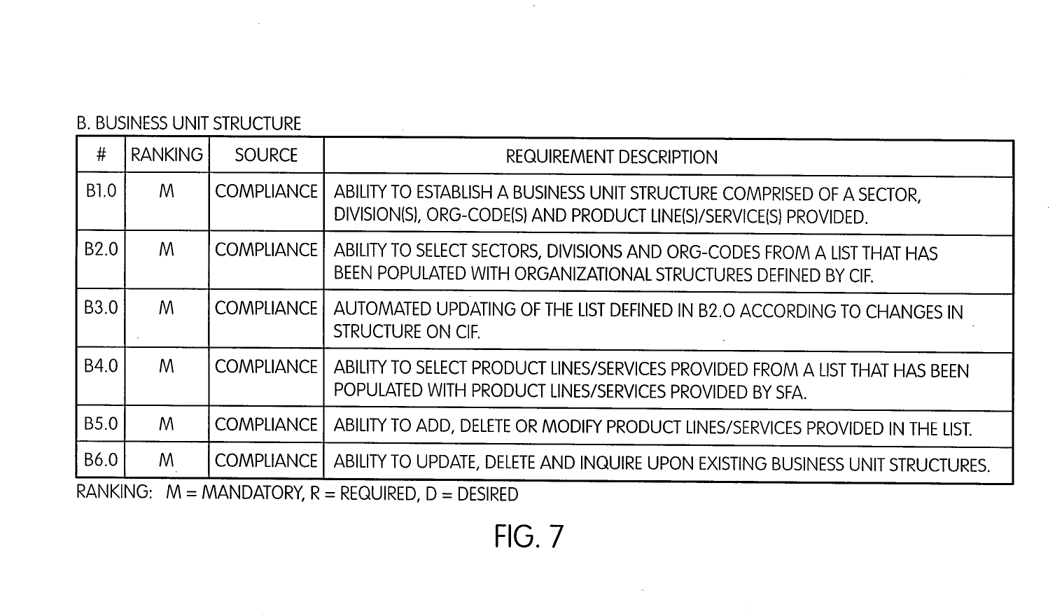

Included in the GCMS is the Business Unit Structure (BUS) composed of sector, division(s), org-code(s) and product line(s)/service(s) provided (an example of which being illustrated in FIG. 7). Sector, division and org-code may be selected by a list populated by organizational structures defined on the Customer Information File (CIF), which is discussed above. Product line/service provided may be selected from a list of all bank services and product lines as defined by a Sales Force Administration (SFA) system. Each compliance officer may be defined by name, RACF ID and function. Each compliance officer may be connected to a BUS or another compliance officer (see FIG. 4).

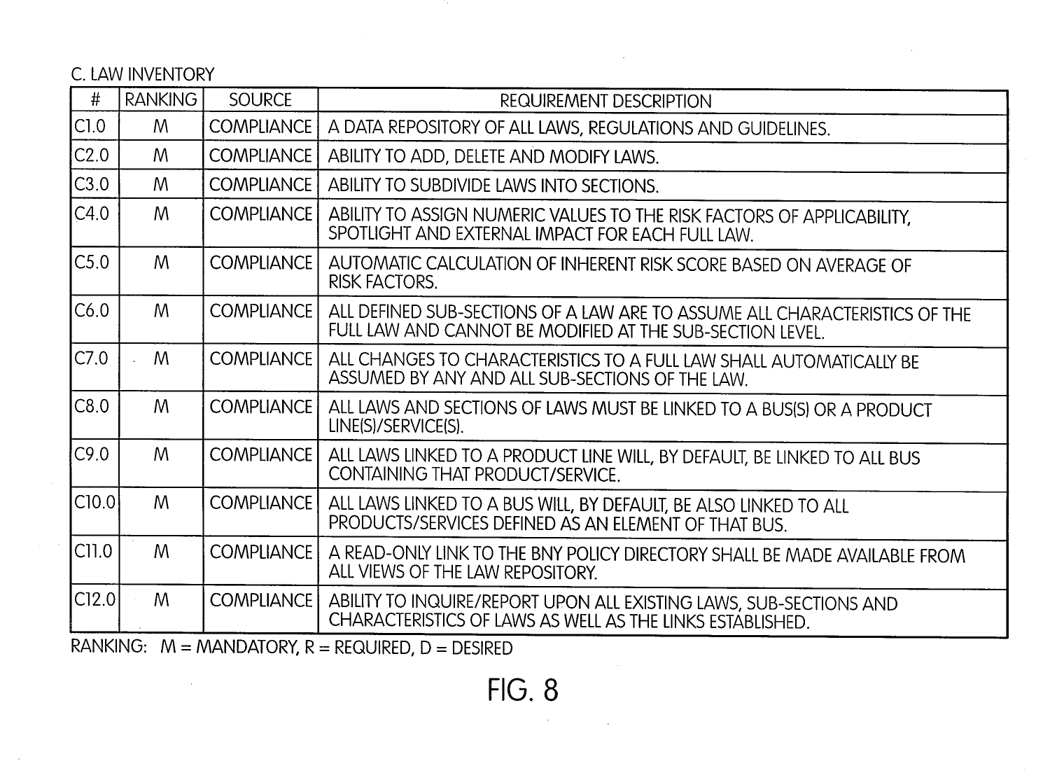

The GCMS may maintain an inventory of all applicable laws, regulations and guidelines (for ease of use, all laws, regulations and guidelines referred to as laws), examples of which being illustrated in FIG. 8. All laws may be sub-divided into sections of the law. Each law, or law section, may be connected to a BUS, then all BUSs that contain that product/service as an element may also be connected to the law. Conversely, if a law is connected to a BUS then all products/services in that BUS may be by default connected to that law. Each law may also contain “risk factors” (applicability, spotlight, external impact) and an “Inherent Score” based on the risk factors.

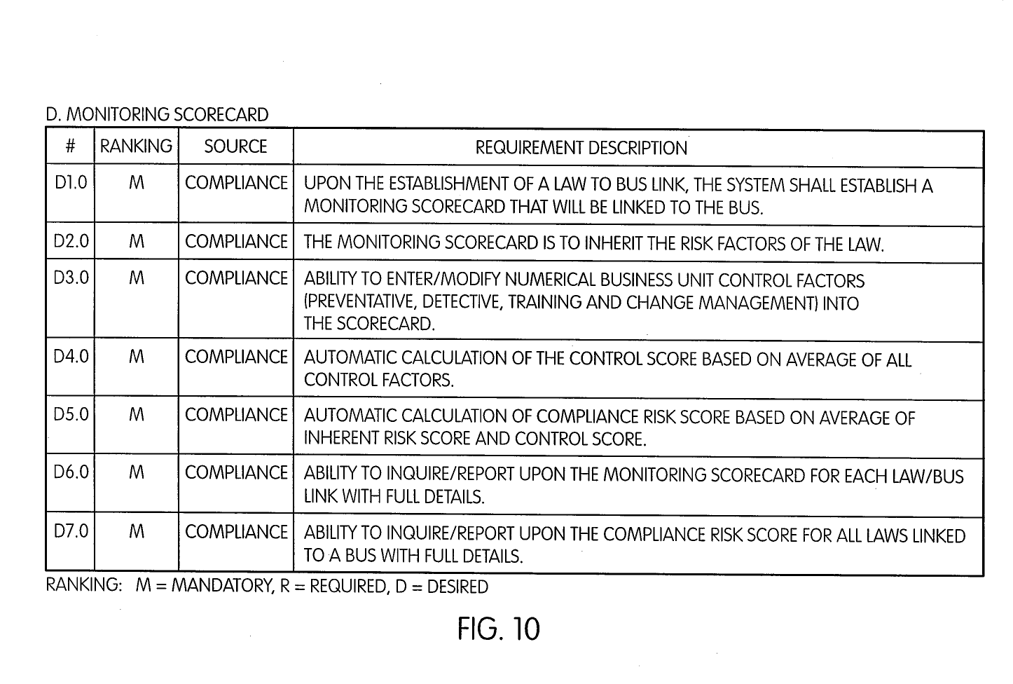

When a Law/BUS connection is established, then the GCMS may create a “Monitoring Scorecard,” an example of which being illustrated in FIG. 10, which inherits the risk factors from the law. The user may then supply the “control factors” to the scorecard that may be used in conjunction with the law's risk factors to determine the “Compliance Risk Score.” These control factors may be weighting constants that add or subtract relative weight to the risk factors. A constant of greater than one would increase the importance of the factor and a constant of less than one would reduce the weight of the factor.

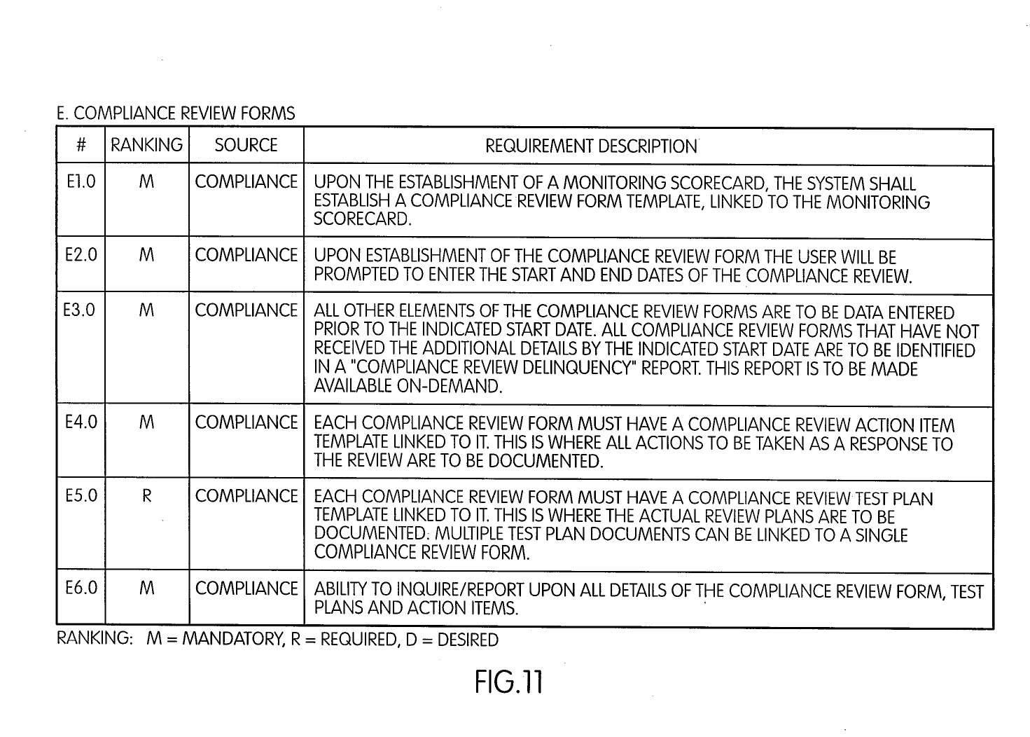

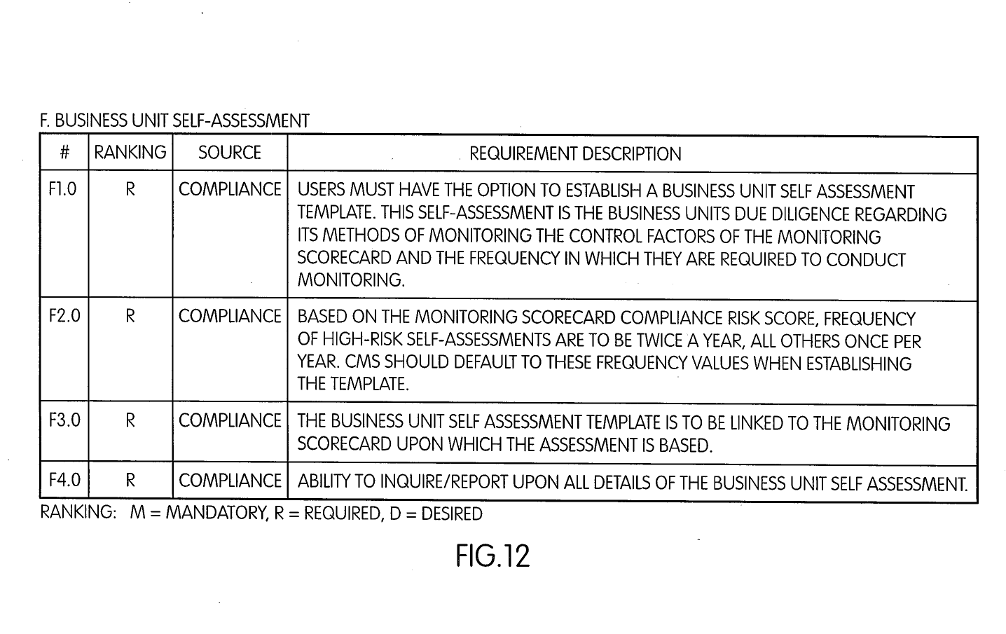

GCMS creates templates for “Compliance Review Forms,” an example of which being illustrated in FIG. 11, and “Business Unit Self Assessment Forms,” an example of which being illustrated in FIG. 12, and connect them to the monitoring scorecard. The data elements of the compliance review form and the business unit self-assessment forms may be data entered.

The compliance review form may also contain templates for a compliance review test plan and compliance review action items. These templates may be completed via data entry.

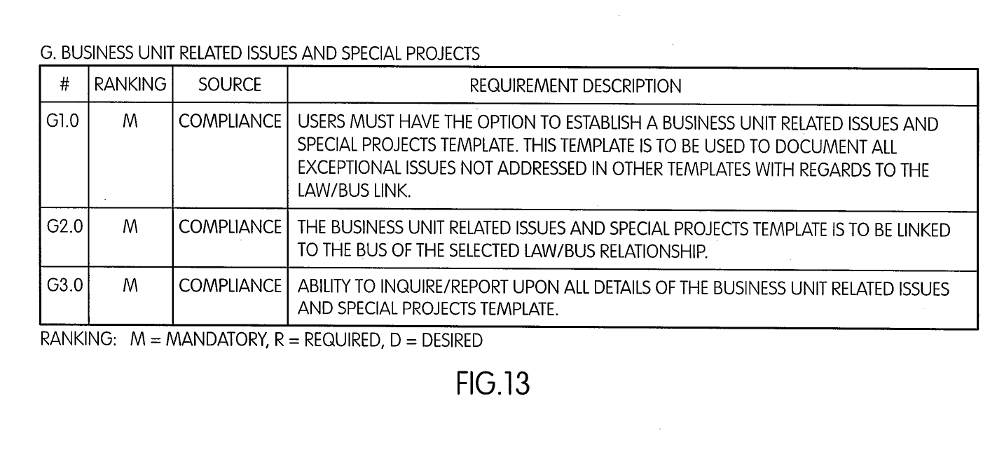

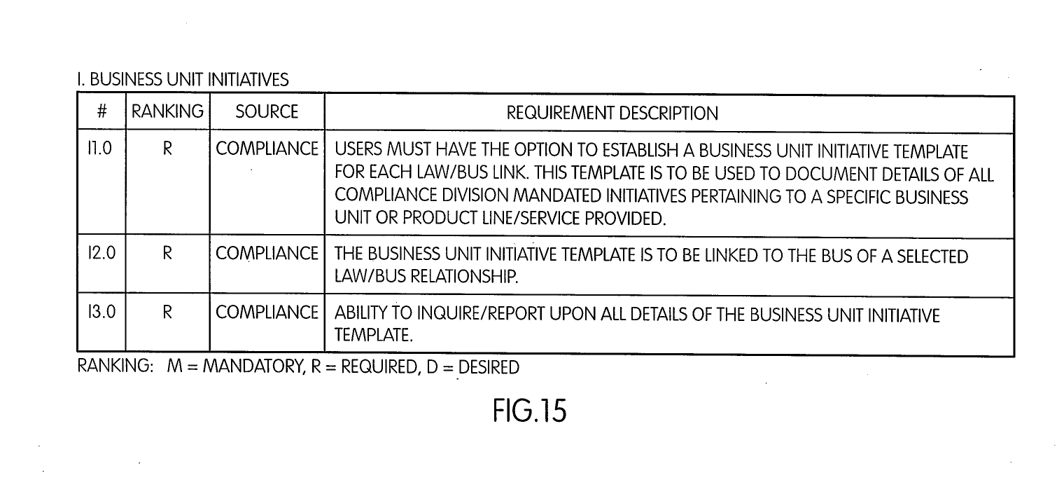

The user may have the ability to establish templates for business unit initiatives, an example of which being illustrated in FIG. 15, and business unit-related issues and special projects, an example of which being illustrated in FIG. 13. These templates may also be contemplated via data entry and connected to a BUS.

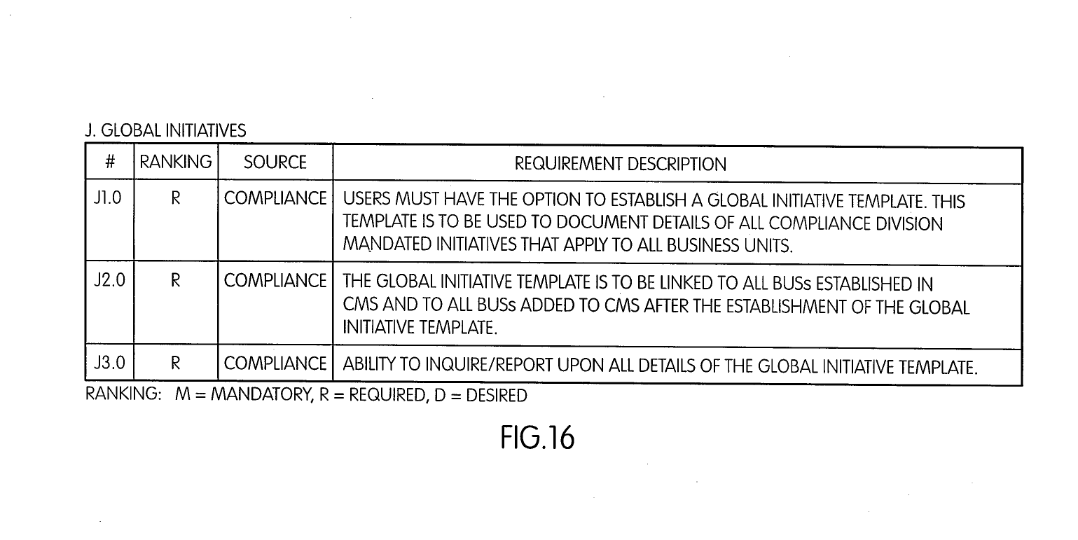

The GCMS may be configured to provide an inventory of all “Compliance Initiatives.” These initiatives may be global, an example of which being illustrated in FIG. 16, and connected to all BUS or an individual BUS, an example of which being illustrated in FIG. 15.

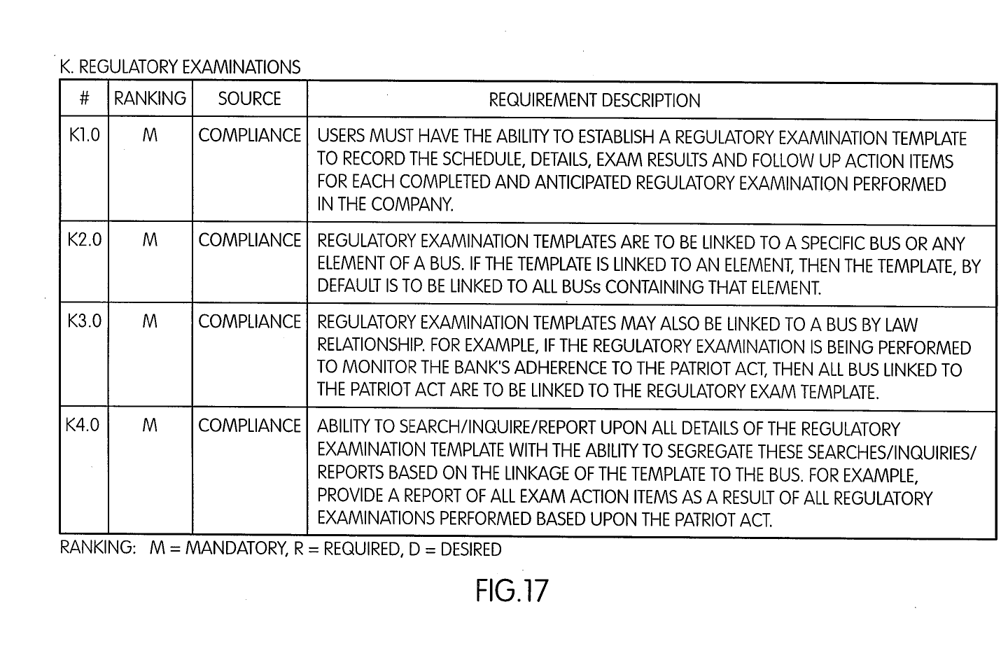

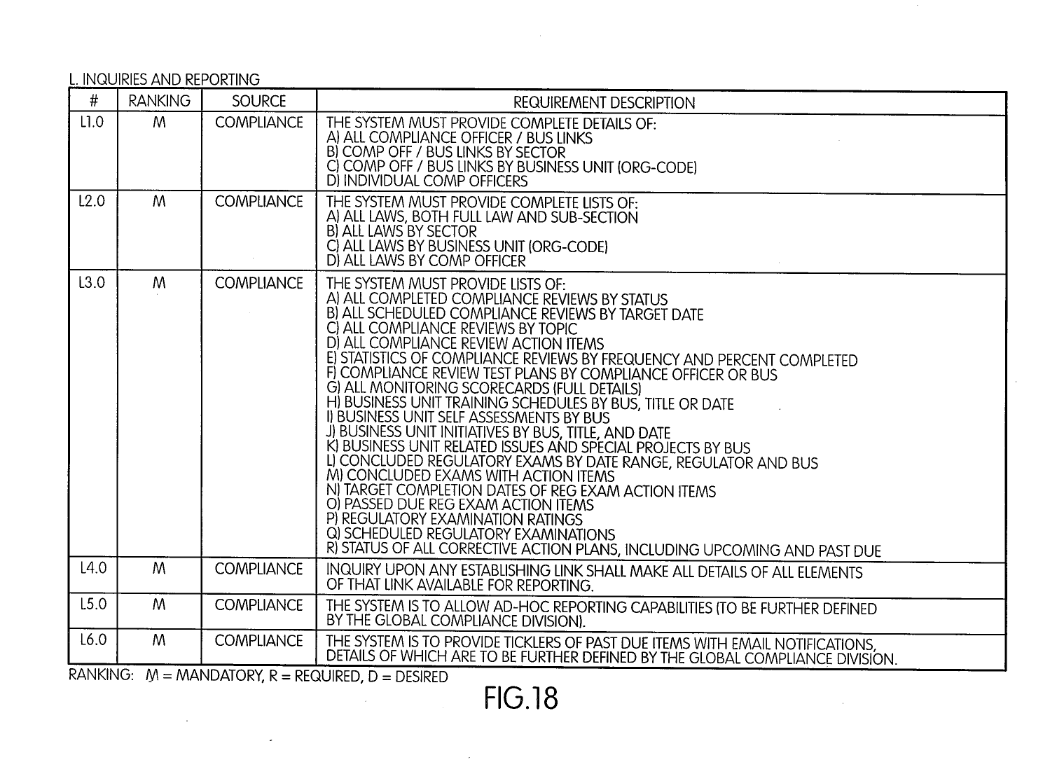

The GCMS may be configured to provide an inventory of all “Regulatory Examinations,” an example of which being illustrated in FIG. 17. These exams may be connected to an individual BUS. All elements of an exam may be data entered and all data elements of an exam may be indexed for searches, inquiries, and reports, an example of which being illustrated in FIG. 18.

Inquires and reports may be available for all elements, with the ability to set criteria based on other elements of a relationship or specified elements of the relationship.

The GCMS may also be used to obtain a list of sectors, divisions and or-codes. The GCMS may be informed of any changes to these organizational structures (i.e., establishment of a new division or org-code).

In accordance with embodiments of the invention, reporting can be performed at a detailed level or at a high level. Relationships also provide a limited ad-hoc reporting capability enhanced by the ‘export to excel’ functionality.

In accordance with embodiments of the invention, the GCMS may be configured to also identify products and services provided by the business units, development of functionality unique to company subsidiaries including broker dealer areas, linkage and tracking of additional business unit specific documents.

In accordance with embodiments of the invention, the GCMS is a repository that incorporates compliance laws, regulations and guidelines, all monitoring programs and processes along with the monitoring results, a comprehensive list of all the regulatory exams and issues, actionable items, steps to address the results, internal and external exams, audits and monitors for program ratings, and new compliance initiatives, scope, tracking, and results.

In accordance with embodiments of the invention, the GCMS may be configured to provide the ability to query data from various perspectives. In accordance with at least one embodiment of the invention, the GCMS may enable information with respect to regulatory exams, compliance with laws, regulations and guidelines, monitoring programs and outcomes, as well as other compliance related materials and data to be stored in a central repository. To maximize the repository's use, the GCMS may also include the ability to query the data at numerous levels (i.e. issues category, response date for exams, trends over all exams globally, ratings, business unit, etc.).

Thus, the GCMS may significantly enhance the ability to manage and report on the company's overall compliance effort and specific issues. The information/data mining capability may enable compliance to track: the number of exams, the issues relative to the exams, actionable issues from exams, regulatory inquiries, monitoring, etc., target dates, action steps, issue resolution, and external risks. All the above elements may be searchable by business unit, sector, rating, category, issue, trends and more.

The GCMS may be configured to be an informational system that enables users of the system to easily access data that shows the areas of responsibility of each compliance officer, laws that affect these areas of responsibility, outcomes and action items resulting from internal and external audits of these areas (including regulatory exams) and all internal programs, initiatives and risk monitoring in place to ensure compliance with applicable laws and regulations. The GCMS system may provide the ability to link these elements in a relationship and to define the characteristics of each element, thereby defining the characteristics of the relationship.

In accordance with embodiments of the invention, the GCMS may have several different levels of security features (i.e. read only, administrative functions, edit, regulatory exams, etc), examples of which being illustrated in FIG. 17. Read only access may be granted to non-compliance personnel and compliance officers may have full update capabilities. The GCMS may be available during working hours and may retain full audit trails of updates and may have pre-defined retention periods for documents.

While the present invention has been described with reference to specific embodiments, it is not confined to the specific details set forth, but is intended to cover such modifications or changes as may come within the scope of this invention.

What is claimed is:

1. A system for enabling automated managing and tracking of compliance issues with regulatory laws and exams through a system comprising:
at least one user interface which is configured to receive data from a user and at least one search term to query a database configured of modules including regulatory laws and business unit structures; and
a report generating system configured to report action items generated from compliance issues resulting from regulatory exams or compliance of any business unit with regulatory laws.

2. The system of claim 1 wherein one or more of the regulatory laws is associated with a business unit structure.

3. The system of claim 2 wherein a risk factor is associated with one of the regulatory laws associated with the business unit structure.

4. The system of claim 1 wherein the report generating system is configured to calculate a compliance risk score for a business unit using a risk factor of a law or regulation and update the database by associating the calculated compliance risk score with a business unit.

5. The system of claim 1 wherein the report generating system is further configured to report action items generated from the compliance issues to an individual, the identity of the individual selected based upon a risk factor identified in a compliance report.

6. The system of claim 1 wherein the database is further configured with information identifying sector, division, and organization codes of the business unit.

7. The system of claim 1 wherein the report generating system is further configured to generate a report associating products or services of a business unit with a law or regulation.

8. A method of managing and tracking compliance issues for a business unit, the method comprising:
storing a compilation of laws and regulations from multiple jurisdictions in a searchable database;
associating one or more of the laws or regulations with a business unit;
assigning a risk factor to one or more of the laws or regulations associated with a business unit;
calculating a compliance risk score for a business unit using the risk factor of a law or regulation; and
updating the searchable database by associating the calculated compliance risk score with a business unit.

9. The method of claim 8 further comprising:
querying the searchable database to obtain the status of compliance for a business unit.

10. The method of claim 8 further comprising:
distributing a compliance report to a first person or a second person, the second person having greater financial authority assigned by the business unit than the first person.

11. The method of claim 8 further comprising:
distributing a compliance report to an individual, the identity of the individual selected based upon a risk factor identified in the compliance report.

12. The method of claim 8 further comprising:
updating business unit information stored in the searchable database by querying a second database storing more current versions of the information.

13. The method of claim 12 wherein the second searchable database is a customer information file containing sector, division, and organization codes for a business unit.

14. The method of claim 8 wherein the business unit operates within a financial institution.

15. The method of claim 8 further comprising:
associating products or services of a business unit with a law or regulation.

16. The method of claim 8 further comprising:
generating a monitoring scorecard, the monitoring scorecard identifying risk factors of the law for a business unit and one or more calculated scores using the identified risk factors.

17. A system comprising:
a searchable database having non-volatile memory;
the searchable database linked to a computer network,
the searchable database storing a plurality of laws or regulations from two or more jurisdictions, the stored laws and regulations configured to be searchable,
the searchable database storing business unit information, the business unit information categorized by at least individual businesses and specific programs, and
the searchable database storing a compliance risk factor for one or more business units.

18. The system of claim 17 wherein the searchable database further stores a plurality of compliance monitoring scorecards, the compliance monitoring scorecards considering previously determined risk factors and adjusted by a weighting constant.

19. The system of claim 17 wherein the searchable database is linked to a wide area network and a customer information file.

20. The system of claim 17 wherein the searchable database is protected by security features that limit access to the database to authorized users.

21. The system of claim 20 wherein different authorized users may have access to different portions of the searchable database.

22. The system of claim 17 wherein the plurality of laws and regulations are banking laws and regulations from at least two jurisdictions.

23. The system of claim 17 further comprising:
a customer information file linked to the searchable database;
a work station linked to the searchable database;
a network server linked to the searchable database; and
a security server linked to the database.
